(19) United States
(12) Patent Application Publication
(10) Pub. No.: US 2011/0277569 A1
(43) Pub. Date: Nov. 17, 2011

(54) INSTRUMENTATION FITTING

(76) Inventor: Douglas RUSH, Greenville, SC (US)

(21) Appl. No.: 12/780,059

(22) Filed: May 14, 2010

(51) Int. Cl. G01L 19/00

(52) U.S. Cl. 73/866.5

(57) ABSTRACT

An instrumentation fitting includes a main body. The main body includes a first end configured to be inserted into an aperture of a vessel and a second end including at least one slot configured to accommodate at least one lead of at least one sensor. The instrumentation fitting further includes a gasket assembly supported by the second end of the main body. The gasket assembly includes a first gasket and a second gasket. The second gasket includes an aperture through which the at least one lead may pass. A flange is secured to the main body. The flange includes at least one aperture configured to receive at least one fastener. A cover plate is configured to be removably attached to the main body by the at least one fastener. The cover plate is configured to contact the first gasket and compress the at least one lead between the first and second gaskets when attached to the main body.

### FIELD OF THE INVENTION

The present invention relates to a fitting used as an instrumentation lead out point on a vessel, for example a test stand or turbine.

### BACKGROUND OF THE INVENTION

Measuring lines, such as thermocouples or pressure measuring lines, are used for obtaining signals indicative of conditions within a test carrier, e.g., a pressure vessel. The measuring lines must be lead out of the test carrier. Various instrumentation fittings are known for leading out the measuring lines. For example, one known fitting used in a conduit is provided with a plurality of sensors that are spread apart and packed with cotton fiber. A paste is then poured into the instrumentation fitting to provide an air-tight seal. The paste takes approximately 24 hours to harden. If the instrumentation fitting needs to be removed, for example to remove a sensor or a lead, the instrumentation fitting must be cut with a grinder and the paste needs to be chipped apart. This process may result in damage to the sensors or leads.

U.S. Pat. No. 5,682,002 discloses a screwed instrumentation fitting for fastening of at least one measuring line to be lead out of a pressure vessel in a casing of the pressure vessel. The instrumentation fitting includes a screw-end socket having external threads and a cap nut. A first external thread is connected to a tapped hole in the casing and the second external thread is connected to the cap nut. A seal is provided between the screw-in socket and the casing, and a conical clamping ring is arranged in the interior of the instrumentation fitting. An axial stop and a conical bearing surface for the clamping ring are also arranged in the interior of the instrumentation fitting. The seal comprises a multi-piece sealing insert arranged in the interior space.

### BRIEF DESCRIPTION OF THE INVENTION

In one embodiment, an instrumentation fitting comprises a main body, the main body comprises a first end configured to be inserted into an aperture of a vessel and a second end comprising at least one slot configured to accommodate at least one lead of at least one sensor; a gasket assembly supported by the second end of the main body, the gasket assembly comprises a first gasket and a second gasket, the second gasket comprising an aperture through which the at least one lead may pass; a flange secured to the main body, the flange comprising at least one aperture configured to receive at least one fastener; and a cover plate configured to be removably attached to the main body by the at least one fastener, the cover plate being configured to contact the first gasket and compress the at least one lead between the first and second gaskets when attached to the main body.

In another embodiment, an instrumentation fitting comprises a main body, the main body comprising a first end configured to be inserted into an aperture of a vessel and a second end comprising a plurality of slots configured to accommodate a plurality of sensor leads; a gasket assembly supported by the second end of the main body, the gasket assembly comprising a first gasket and a second gasket, the second gasket comprising an aperture through which the sensor leads may pass; a flange secured to the main body, the flange comprising eight threaded apertures; eight threaded fasteners threadable into the eight threaded apertures; and a cover plate configured to be removably attached to the main body by the eight threaded fasteners. The cover plate is configured to contact the first gasket and compress the sensor leads between the first and second gaskets when attached to the main body.

### BRIEF DESCRIPTION OF THE DRAWINGS

FIG. 1 schematically illustrates an exploded assembly view of an instrumentation fitting according to an embodiment of the invention; and

FIG. 2 schematically illustrates an assembly drawing of the instrumentation fitting of FIG. 1.

### DETAILED DESCRIPTION OF THE INVENTION

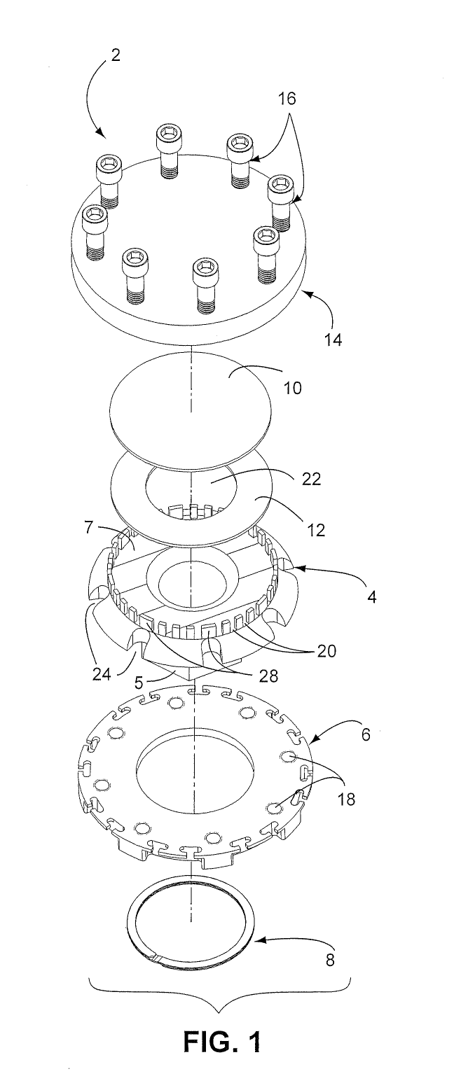

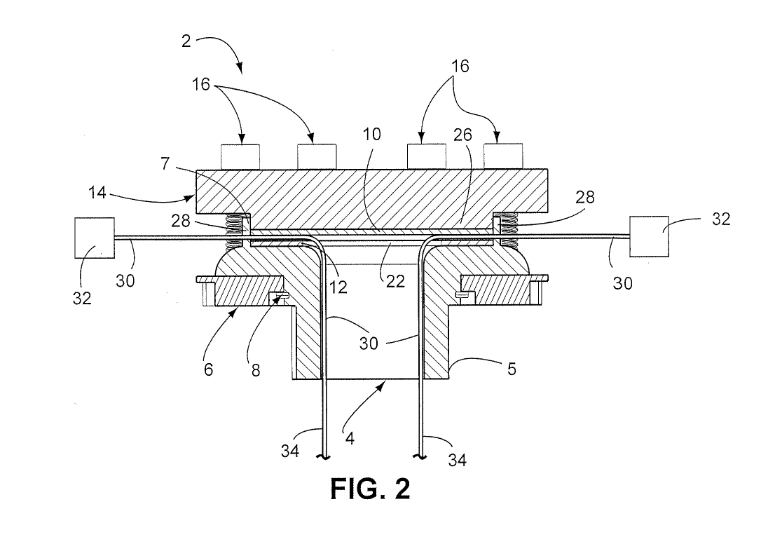

Referring to FIGS. 1 and 2, an instrumentation fitting 2 comprises a main body 4. The main body 4 comprises a first end 5 may be arranged in a hole or aperture in a vessel, for example a test stand or a turbine. A sensor feed through flange 6 is connected to the main body 4 by a retaining ring 8, for example a spiral wound retaining ring.

The main body 4 comprises a second end 7 that includes a plurality of lead out slots 20. The leads (not shown) from sensors (not shown) are routed through the lead out slots 20 for connection to, for example, a measuring instrument such as a temperature measuring instrument or a pressure measuring instrument. The lead out slots 20 may be machined in the main body 4. The shape and size of the individual lead out slots 20, and the total number of lead out slots 20, may be varied depending upon the shape and size, and the number of leads to be accommodated in the instrumentation fitting 2.

A first gasket 10 and a second gasket 12 are arranged inside the area defined by the lead out slots 20. The leads from the sensors are provided between the first gasket 10 and a second gasket 12. The leads from the individual sensors are threaded through a gasket aperture 22 in the second gasket 12 and then out through the lead out slots 20.

A cover plate 14 is provided to compress the first gasket 10 and the second gasket 12. The cover plate 14 is fastened to the instrumentation fitting 2 by a plurality of fasteners 16. Although eight fasteners 16 are shown in the drawings, it should be appreciated that another number of fasteners may be used, for example one or two or three or four or five or six, etc. As shown in FIGS. 1 and 2, the fasteners 16 comprise bolts, although it should be appreciated that other types of fasteners, for example other types of threaded fasteners, may be used instead. The fasteners 16 are received in respective threaded apertures 18 in the flange 6. The main body 4 comprises a corresponding number of recesses 24 to permit the fasteners 16 to be received in the apertures 18 of the flange 6. The recesses 24 of the main body 4 accommodate the passage of the fasteners to permit the connection of the cover plate 14 and the flange 6. As shown in FIGS. 1 and 2, a stop 28 is provided on the main body 4 at the location of each recess 24 to prevent a lead from being contacted and/or damaged by the fasteners 16 passing through the recesses 24.

An airtight seal is affected by compressing a sensor lead, or measuring line, 30, between the first gasket 10 and a second gasket 12 and securing the instrumentation fitting 2 by securing the cover plate 14 to the main body 4 by tightening the fasteners 16 in the threaded apertures 18 of the flange 6. As shown in FIG. 2, the cover plate 14 comprises an extended portion 26 that is received within the ring of the slots 20 and contacts the first gasket 10. The first gasket 10 does not include an aperture and is configured to seal against the entire between the slots 20. The first gasket 10 seals against the entire area of the extended portion 26. As the fasteners 16 are tightened, the extended portion 26 compresses the first and second gaskets 10, 12 together. If a sensor lead, or measuring line, 30 needs to be removed or replaced, the cover plate 14 can be removed simply by removing the fasteners 16 from the apertures 18 of the flange 6. Similarly, if the first gasket 10 and/or the second gasket 12 needs to be removed or replaced, the gasket(s) can be replaced simply by removing the cover plate 14 from the main body 4 by removing the fasteners 16.

The sensor lead(s) 30 exits the fitting 2 through one of the lead out slots 20. An outer end of the sensor lead(s) 30 may be connected to a coupling 32, for example a plug, which may be connected to a measuring instrument (not shown), such as a temperature or pressure measuring instrument, either directly or through an additional lead or line. An inner end 34 of the sensor lead(s) 30 may form a measuring point inside the vessel.

The instrumentation fitting described above reduces the time needed to replace sensors and leads, and also reduces the possibility of damage to the sensors and/or leads during replacement of the sensors and/or leads. The instrumentation fitting described above is also less time consuming to install and remove than existing instrumentation fittings and can be used anywhere instrumentation sensors are lead out of a pressure vessel or turbine.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. An instrumentation fitting, comprising:
a main body, the main body comprising a first end configured to be inserted into an aperture of a vessel and a second end comprising at least one slot configured to accommodate at least one sensor lead;
a gasket assembly supported by the second end of the main body, the gasket assembly comprising a first gasket and a second gasket, the second gasket comprising an aperture through which the at least one sensor lead may pass;
a flange secured to the main body, the flange comprising at least one aperture configured to receive at least one fastener; and
a cover plate configured to be removably attached to the main body by the at least one fastener, the cover plate being configured to contact the first gasket and compress the at least one sensor lead between the first and second gaskets when attached to the main body.

2. An instrumentation fitting according to claim 1, wherein the at least one slot is machined in the second end of the main body.

3. An instrumentation fitting according to claim 1, wherein the at least one fastener comprises at least one threaded fastener and the at least one aperture of the flange comprises a threaded aperture.

4. An instrumentation fitting according to claim 3, wherein the at least one threaded fastener comprises a bolt.

5. An instrument fitting according to claim 1, wherein the flange is secured to the main body by a retaining ring.

6. An instrumentation fitting according to claim 1, wherein the main body comprises at least one recess in the second end that is aligned with the at least one aperture of the flange, and the at least one fastener is accommodated in the at least one recess when the fastener is received in the at least one aperture of the flange.

7. An instrumentation fitting according to claim 1, further comprising at least one stop provided at the second end of the main body at the at least one recess.

8. An instrumentation fitting according to claim 1, wherein the at least one aperture in the flange comprises eight apertures and the at least one fastener comprises eight fasteners.

9. An instrumentation fitting according to claim 1, wherein the cover plate comprises an extended portion that extends into the second end of the main body to contact the first gasket.

10. An instrumentation fitting according to claim 9, wherein the first gasket is configured to seal against the entire extended portion of the cover plate.

11. An instrumentation fitting according to claim 1, wherein the at least one slot comprises a plurality of slots, and each slot is configured to accommodate a lead.

12. An instrumentation fitting according to claim 1, wherein the vessel comprises a test stand.

13. An instrumentation fitting according to claim 1, wherein the vessel comprises a turbine.

14. An instrumentation fitting, comprising:
a main body, the main body comprising a first end configured to be inserted into an aperture of a vessel and a second end comprising a plurality of slots configured to accommodate a plurality of sensor leads;
a gasket assembly supported by the second end of the main body, the gasket assembly comprising a first gasket and a second gasket, the second gasket comprising an aperture through which the sensor leads may pass;
a flange secured to the main body, the flange comprising a plurality of threaded apertures;
a plurality of threaded fasteners corresponding the plurality of threaded apertures, the plurality of threaded fasteners being threadable into the plurality of threaded apertures;
a cover plate configured to be removably attached to the main body by the plurality of threaded fasteners, the cover plate being configured to contact the first gasket and compress the sensor leads between the first and second gaskets when attached to the main body.

15. An instrumentation fitting according to claim 14, wherein the plurality of threaded apertures comprises eight threaded apertures and the plurality of threaded fasteners comprises eight threaded fasteners.
